(19) United States
(12) Patent Application Publication
(10) Pub. No.: US 2005/0251862 A1
(43) Pub. Date: Nov. 10, 2005

(54) Security arrangement, method and apparatus for repelling computer viruses and isolating data

(76) Inventor: Jarmo Talvitie, Tuusula (FI)

Correspondence Address: YOUNG & THOMPSON, 745 SOUTH 23RD STREET, 2ND FLOOR, ARLINGTON, VA, 22202, US

(21) Appl. No.: 10/527,814

(22) PCT Filed: Sep. 11, 2003
(86) PCT No.: PCT/FI03/00664

§ 371 Date: Mar. 14, 2005

(30) Foreign Application Priority Data
Sep. 12, 2002 (FI) 20021635

(51) Int. Cl. H04L 9/32

(52) U.S. Cl. 726/24; 713/188

(57) ABSTRACT

A security system, method and apparatus for repelling computer viruses and isolating data. The security system includes sub-systems 1-3, which sub-system 1 includes an addition to anti-virus software those programs of sub-system 3 that may cause the activation of a virus. Sub-system 2 functions as a intermediate stage between sub-systems 1 and 3. In the presented method, actions are taken to activate a virus and to detect virus activation. In connection with virus activation the security system or its part can be separated from the rest of the system and thereby limit damages. When the security system is placed between two systems, it can also be used to isolate the two systems mentioned above from each other with regard to direct, real-time data transfer. The apparatus is adapted to receive a message from another apparatus and to examine the message in order to activate and to detect unknown viruses.

The invention relates to computers, information networks and communication systems, and in particular to the repelling of viruses in these.

Viruses appearing in computers are pieces of programs the main purpose of which is to propagate. Many viruses cause in addition, either intentionally or unintentionally, damage to the host computers in which they have become activated. Viruses may make themselves known by displaying messages on the computer's screen or by destroying files. A virus is typically attached to one or more files and will become active once the said file is opened or, when the file is a program, once the program is launched. After becoming active, the virus may attach itself to other files, make itself apparent to the computer's user or cause damage, inter alia, by destroying contents of the working storage or the mass storage. Before the age of the Internet, viruses were typically spread from one piece of hardware to another by means of disks. Nowadays, the most common sources for contamination are the loading of infected files from the Internet or the opening of e-mail messages carrying viruses. Huge information networks such as the Internet are excellent environments for the extensive spreading of viruses, as tracking down the original spreader is difficult due to the dynamic nature of the network and partially because the network protects the anonymity of its users; on the other hand, there are virtually countless potential catchers of viruses around the world.

Virus being a rather generally applied term, one can divide it into subcategories such as worms and trojan horses. Worms are programs that are able to propagate independently from any action taken by the user favourable for a virus and usually required by traditional viruses in order to become active. Worms use, for example, features enabling the automatic sending and/or receiving of files integrated into modern computers and computer systems. The term “trojan horse” is based on the archetypal deception carried out in ancient Greece and is an indication of the treacherous nature of the program given the same name. A trojan horse is a program most of the time disguised as something else, a program with either a useful or an entertaining purpose. A trojan horse can also carry features of traditional viruses or worms. In addition to common files, some viruses can attach themselves to the boot sector of the mass storage of a computer on the hard disk or a diskette. These viruses are typically activated immediately after turning on the computer or when reading the contents of a diskette. Viruses may, on the other hand, make themselves remain undetected by observing system calls run in a computer and dealing, for example, with memory blocks of mass storage, and restore the caller application with the original saved contents of the memory blocks, instead of the current data altered by the virus.

One can protect oneself from traditional viruses, worms, trojan horses as well as their combinations by using a wide variety of different methods. Most of the time, anti-virus programs installed in computers are run constantly as so-called background processes and they are placed in connection with the starting of the computer at least partially in the working storage to control the data transfer between the information network and the computer connected thereto, the computer's own internal operations and the contents of the mass storage, at least indirectly. The internal operations of a computer pertain, for example, to the handling of memory and files and to the controlling of peripheral equipment. Anti-virus programs usually contain a database of such features of known viruses, so-called fingerprints, that are characteristic of each virus or type of virus. When a new file, for example a program, is saved in the computer's working storage, the anti-virus software in the computer's memory will perform a search comparing the features of known viruses to the information contained in the said file.

Important files can be protected separately by using, for example, CRCs (Cyclic Redundancy Checks) or so-called hash checks. If the check run in the file is not consistent with the original, a virus has possibly attached itself to the file and has altered the information contained therein.

The database of classic anti-virus software must always be updated to contain the characteristics of a new virus before the virus can be reliably detected and identified. So-called polymorphic viruses can transform themselves in connection with their copying, and therefore they are particularly difficult to detect using traditional anti-virus programs. The mutations of a polymorphic virus may contain the same actions realized by different series of commands, thus maintaining the function of the virus, however, anti-virus programs based on finger prints can no longer reliably identify different variations as viruses. On the other hand, even if all possible types of virus and their mutations could be identified, the space required to store the characteristics and correspondingly the time to locate these would soon escalate to an unreasonable level.

The publication U.S. Pat. No. 5,889,943 presents a system where a closed network is connected to an external network by a gateway. This gateway will examine all messages coming in by the external network as well as messages leaving through it to prevent possible virus infections. The internal traffic is not examined. The publication furthermore presents a separate apparatus to be installed in the user's computer. The apparatus includes a polling module to detect new messages in the network's common postal node, a retrieval module to receive messages from the postal node and an analysis/treatment module to detect viruses in messages.

The publication U.S. 2002/0095607 presents an apparatus to be installed between the actual core part of a personal computer and an external data network. The apparatus includes a so-called ghost address book with ghost addresses. When a virus tries to take control of the address book in order to send itself to all addresses listed, the action is detected and an alarm is given.

The objective of the Invention is to avoid the afore-mentioned weaknesses present in traditional anti-virus methods and systems with the help of a new security system, a method applied therein and a new apparatus.

A security system protecting computers and computer networks from viruses, as covered by the Invention, which security system is adapted to forward messages is charaterized in that it includes a first sub-system to detect unknown viruses, which sub-system is adapted to take at least one action to activate unknown viruses in connection with the forwarding of messages or other action, or in a timed manner.

The Invention further covers a security system for repelling viruses in computers and data networks, which security system is adapted to forward messages, for which security system is characteristic that it includes a first sub-system for detecting unknown viruses, which first sub-system is adapted to compare messages with at least partially same identifiers with each other in order to detect unknown viruses.

In addition to the above, the Invention covers a method for protecting computers and computer networks from viruses, which method is characterized in that it is performed in a system including a first sub-system to forward messages and to detect viruses, which first sub-system can be isolated in respect of information transfer from the other system, which method includes stages where:
the actions of the system are monitored in order to detect viruses,
a virus is detected when at least one of the following conditions is met: a change takes place in the first sub-system prior to actions causing changes carried out by the first-mentioned sub-system, a change takes place in the first sub-system that is not an action taken by the said sub-system to detect a virus, a message leaves for another system without command from the first sub-system, a message leaves for another system to a wrong address or to a system which no communication has been directed to, a message does not leave for another system although it has been sent there,
an alarm is given.

In addition to the above, the Invention covers a method for repelling viruses in computers and computer networks, which method is characterized in that it has stages where:
at least one action in the system is taken in connection with the forwarding of messages or other action, or in a timed manner, in order to activate a virus,
the actions of the system are monitored in order to detect an occurrence initiated by virus activation,
an alarm is given when a virus is detected.

In addition to the above, the Invention covers an apparatus for repelling viruses in computers and computer networks, which apparatus includes equipment for saving and handling data and equipment for transferring data with another apparatus, for which first-mentioned apparatus is characteristic that it is adapted to receive a message from the other apparatus mentioned and to perform at least one action in order to activate viruses contained in the message.

In accordance with one preferred embodiment of the Invention, a security system is established for repelling computer viruses, which system includes sub-systems 1-3. The sub-system 1 is a “porch” or “mudroom” that forwards communication between the external system and the sub-system 3, the so-called user system.

Messages arriving from outside the security system that are usually directed to users to the sub-system 3 are first sent from sub-system 1 to the “entrance hall”, i.e. sub-system 2 from which they are later directed to sub-system 3. Sub-system 2 includes addresses corresponding with each address of sub-system 3, for example, an IP address of a computer or an e-mail address of a user, through which the messages are forwarded between sub-systems 1 and 3. Sub-system 1 has the information how the address data of sub-systems 2 and 3 can be combined with each other in order to forward incoming messages conveniently to an address in sub-system 2 corresponding with an address in sub-system 3. There is also a secure connection from sub-system 1 to sub-systems 2 and 3. Messages from sub-system 3 to an external system can correspondingly be recycled through sub-systems 1 and 2 of the security system. Sub-system 1 includes such programs and functions of sub-system 3 that a virus might in some way make use of. In addition, sub-system 1 includes such programs and functions that are justifiable in order to locate a virus. Such programs may be, for example, anti-virus programs and programs that may help to activate a virus. If desired, even other programs and functions that are not part of sub-system 3 can be included in sub-system 1 within the limits of its performance and memory capacity. Sub-systems 1-3 can, if needed, be added to (sub-)systems X, if so is deemed necessary in respect to repelling viruses. If a virus is detected in sub-system 1, a protection command is sent to sub-systems 2 and 3 via a secure connection. When a virus is activated in sub-system 1 of the security system, its damages will be limited to sub-systems 1-2, preventing or at least remarkably minimizing damages in sub-system 3 or in any other system connected to the security system to be protected, as it is possible for the sub-systems in relation to communication to be separated from each other or any other system connected thereto, such as an external data network, for example, when a virus attack is detected.

In a network environment, the security system can be installed centralized at a data receiving/forwarding point. As regards individual computers, including mobile phones and PDAs, the system can be implemented as a service offered by an operator or a new type of computer including a number of systems (sub-systems 1-3) in accordance with the Invention. The security system does not necessarily require any additional equipment to be able to function, but it can in many cases be implemented on a software basis in an existing system using its network elements such as a server or a router, which network elements contain a memory, for example a RAM memory circuit, and a non-volatile memory such as a hard disk to save data, for example a computer program, as well as a processor to carry out the functions defined by the said program.

In accordance with another preferred embodiment of the Invention, sub-system 2 is left out of the implementation of the security system, if one can guarantee the arrival of a protection command at sub-system 3 prior to other messages possibly infected by a virus. In that case one would still achieve a high level of protection from virus attacks and the system would be simpler in its overall structure than the former embodiment, also enabling lower hardware requirements than before.

In accordance with a further preferred embodiment of the Invention, a security system is established in order to isolate data between two systems. Files are transferred from an external system to an internal system, for example to sub-system 3, i.e. the user system, gradually through sub-systems 1 and 2. In order to isolate data between the user's sub-system 3 and the external system, the connection between the external system and sub-system 1 is disrupted when the connection between sub-systems 1 and 2 is open, and the connection between sub-systems 1 and 2 is disrupted when the connection between sub-systems 2 and 3 is open. One can proceed correspondingly when transferring data from the internal system to the external system. With the help of the presented staggered communication between the sub-systems one can hinder unauthorized intrusions into the user's system.

Embodiments of the Invention are described in the dependent Patent claims.

Hereinafter the Invention is described in more detail by reference to the attached drawings.

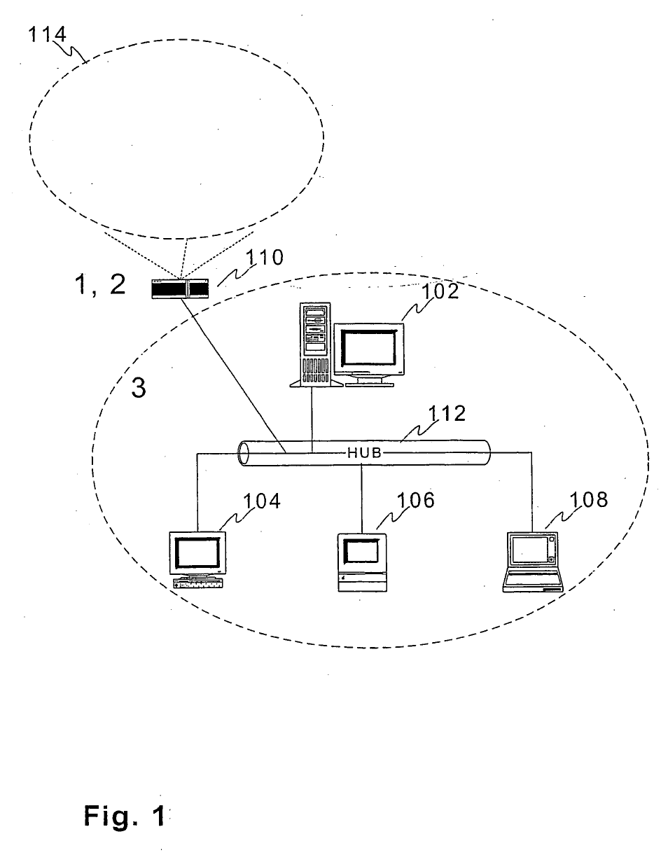

FIG. 1 presents a security system in accordance with the first preferred embodiment of the Invention that is connected to an external system by means of a router, and the sub-system 3 of which includes three computers of users and an e-mail server,

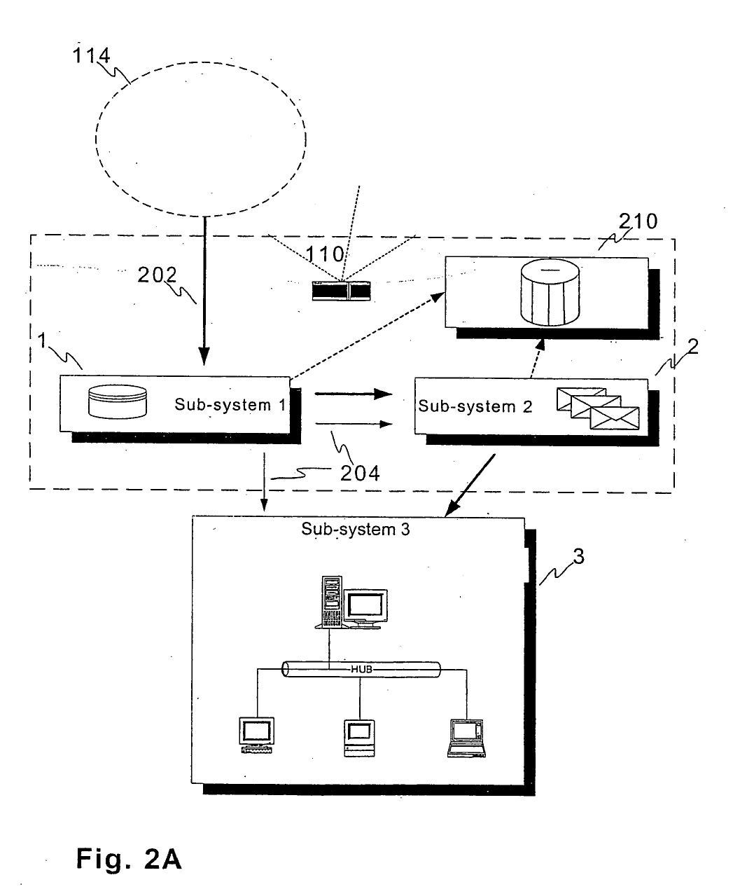

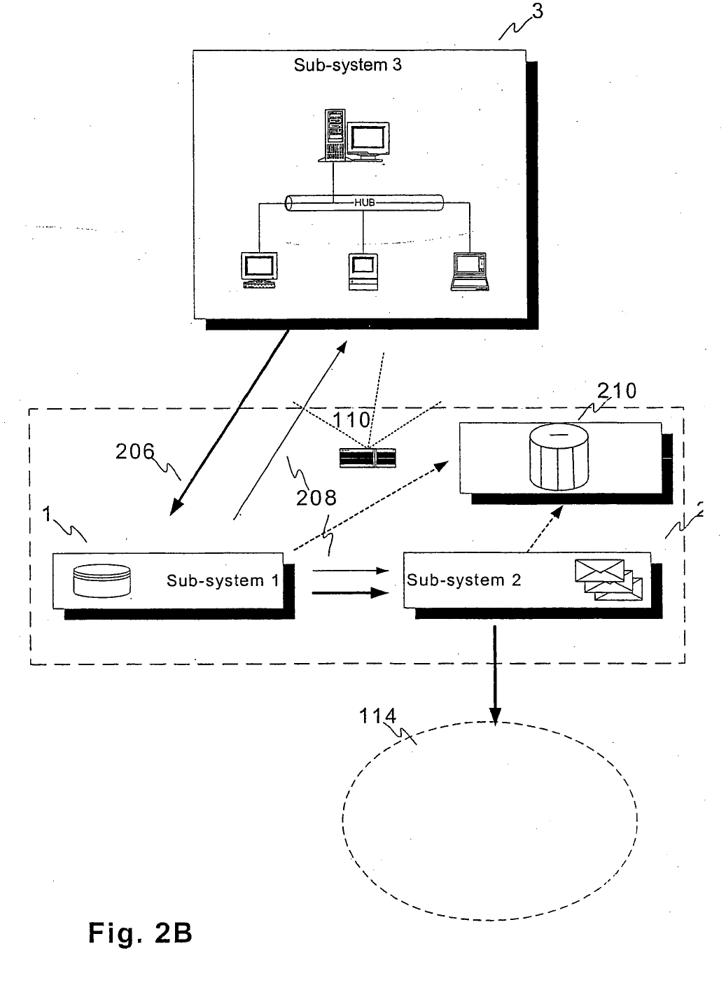

FIGS. 2A and 2B present different sub-systems of a security system in accordance with the Invention and the connections between them,

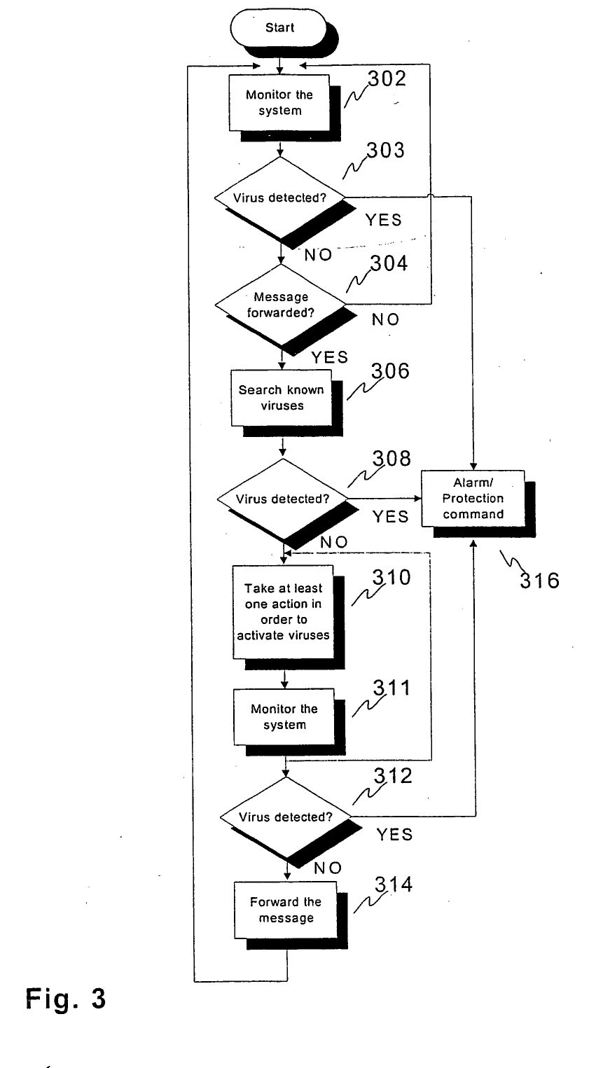

FIG. 3 presents a flow chart showing one implementation alternative for an anti-virus method to be performed in a security system in accordance with the Invention,

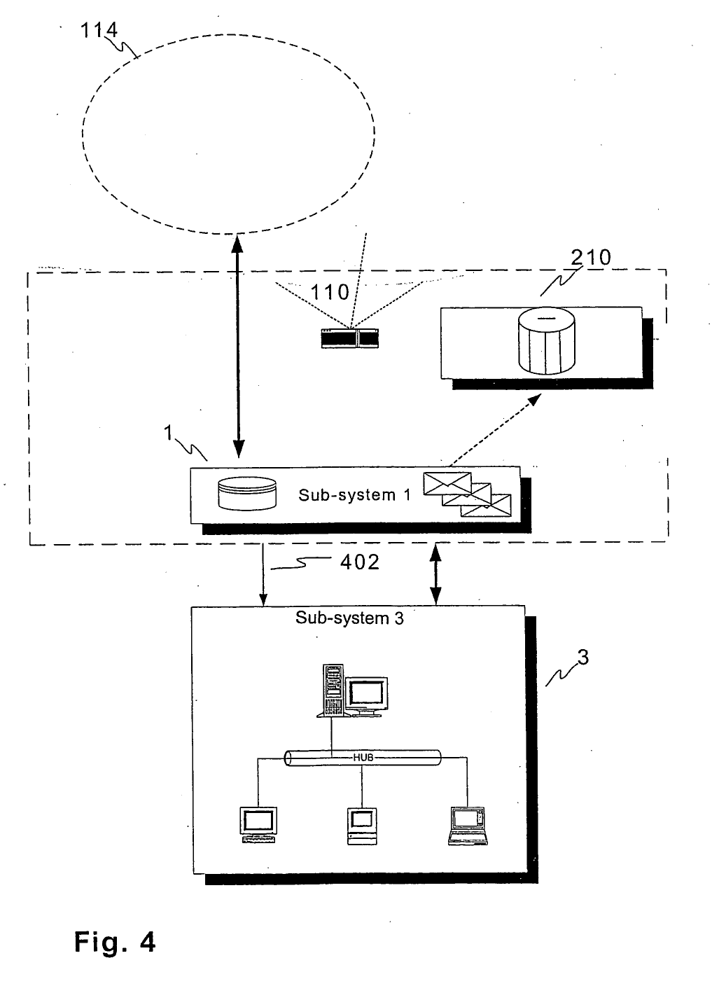

FIG. 4 presents a security system in accordance with a second preferred embodiment of the Invention, where sub-system 2 is left out of the implementation of the security system,

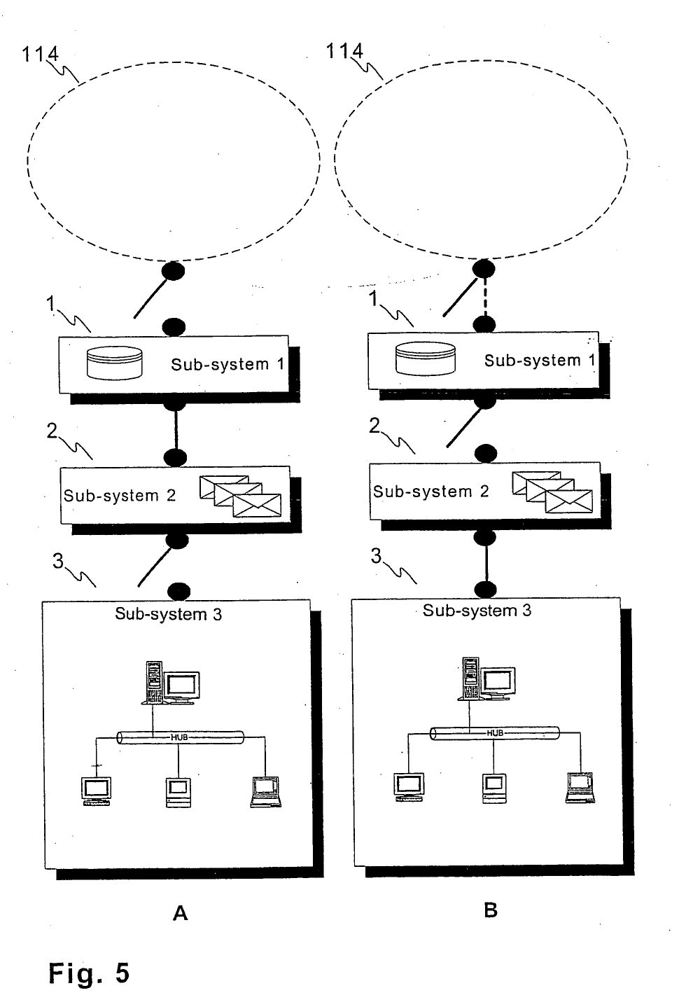

FIG. 5 presents a security system in accordance with a third preferred embodiment of the Invention for isolating data from the external network,

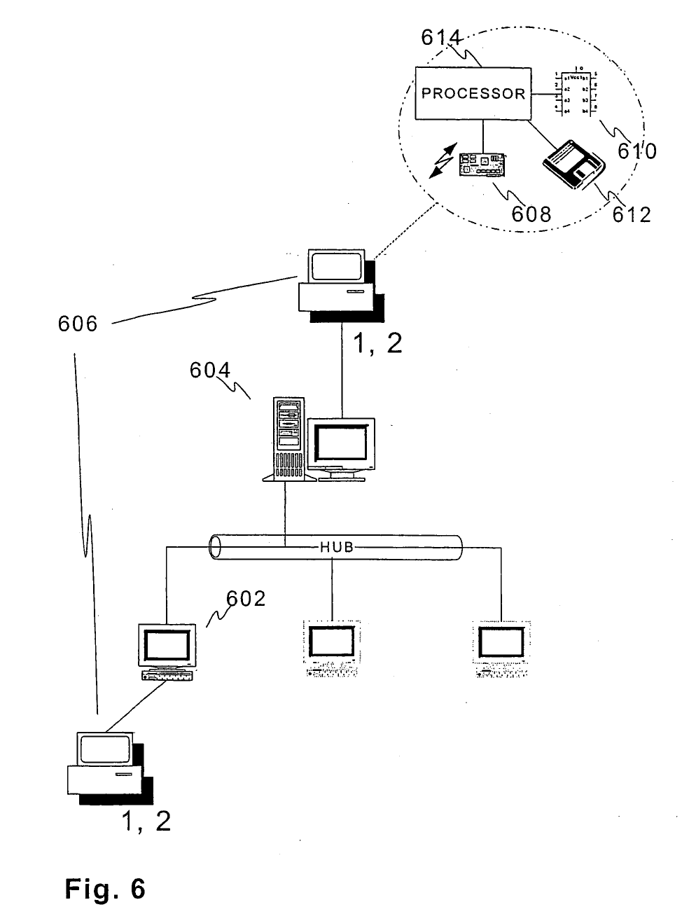

FIG. 6 presents an apparatus in accordance with the Invention and another system connected thereto.

FIG. 1 presents the internal network of a small enterprise, a so-called local area network, that functions at the same time as the user's system and the third sub-system 3 of a security system in accordance with the Invention, including three computers 104, 106, 108 and an e-mail server 102. Communication in the network takes place through HUB 112. Connections to an external system 114, for example a national data network, has been adapted to go through router 110. Functions of server 102 and router 110 can be carried out in the same computer, if desired. Sub-systems 1 and 2 of the security system are in this example situated in connection with router 110, but from the point of view of the Invention, it is relevant that e-mail messages possibly infected by a virus cannot reach sub-system 3 or external system 114 before being examined at a suitable interface that can be separated from the local area network, if needed. Therefore the security system can in a typical case be included in, for example, one or more separate computers between the gateway of the external network and the internal network. Should this, however, not be possible, one can by all means implement the security system in each computer of the local area network separately. In the Internet, the duty of the Internet Protocol is to route the IP data to the correct recipient. Usually, the databases of DNS (Domain Name Service) servers contain special MX (Mail eXchanger) entries that define for domain names their own mail servers which all messages addressed to the said names are directed to. One wants to make mail servers, for instance the general SMTP (Simple Mail Transfer Protocol)/POP (Post Office Protocol) servers, as reliable as possible, and there may be several of them working in the same network area, prioritized in different ways in order to have messages saved in the system, even if the recipient was not immediately available. The DNS service can in a network as presented in FIG. 1 be situated, for example, in router 110 that directs mail communication arriving at local area network 3 automatically to server 102. Further information regarding the routing of messages in respect of the DNS system can be found, inter alia, in Reference [1]. A router can also include the functions of NAT (Network Address Translation) that help situate the computers of the internal data network in a different (type of) address space than used in the external network.

Server 102 and computers 104, 106, 108 are connected to an Ethernet type local area network by means of a different hub 112. Other possible network solutions are, inter alia, Token Ring, FDDI (Fiber-Distributed Data Interface) and ATM (Asynchronous Transfer Mode). The cabling used in a local area network, i.e. sub-system 3 of the security system, can be, for instance, pair or coaxial cable. On the other hand, it is possible to make use of wireless solutions such as WLAN (Wireless LAN) when connecting, for example, laptops, mobile phones or PDAs to the network. Hub 112, including several ports for connecting computers, will send by default the data received through one port to all other ports. The then established network topology is only apparently star-shaped/radial, as it remains all the same a logical bus; apparatus connected to the bus will also detect messages sent by all others, if desired. The access mechanism in Ethernet networks is CSMA/CD (Carrier Sense Multiple Access/Collision Detect) where the computer will first listen if the network is available and only then start sending the data in package form. Several computers can start sending at the same time, so the sender also has to listen to the bus during the transmission in order to avoid possible collisions in the data transfer. When detecting collisions, the sender is silent for a random period of time before a new transmission.

Within sub-system 3, the data is directed from a computer or an apparatus to another with the help of so-called MAC (Medium Access Control) addresses and to/from an external network with the help of IP addresses. Thus every apparatus connected to an network has its own MAC and IP address. ARP (Address Resolution Protocol) enables the identification of a MAC address corresponding with an IP address in a local area network. An address query is sent to the network without any defined recipient, but router 110 does not forward the query to the outside from the local area network, in this case sub-system 3. The apparatus identifying the IP address in question responds directly to the sender of the query. After having learned the searched IP-MAC equivalence, the sender of the query enters it in its ARP table and can thus in the future send the data frame directly to the recipient without any queries. When sending out data from sub-system 3, it must first be transferred to router 110 that will take care of the data transfer with the outside world. If the sender detects that data is being directed outside of the local area network, it may direct communication directly to router 110 the LAN address of which is known by the sender. Otherwise the apparatus will broadcast an ARP message inquiring what LAN address corresponds with the IP address of the recipient of the package. Router 110 detects that the recipient of the package is located outside sub-system 3 and responds to the query with its own LAN address. Thereafter, the sender forwards the message to router 110. Outside the local area network, for example in a wide area network, the routing of messages is usually based on using some internal routing protocol, such as RIP (Routing Information Protocol) and OSPF (Open Shortest Path First). Between autonomous areas, for example network operators or companies in different countries, so-called external routing protocols are used, for example BGP (Border Gateway Protocol), as in that case, the route is chosen not only on the basis of efficiency, but even other factors affect the choice: for instance, political, financial or security factors limit the choice of eligible routes. The limitations mentioned above, along with routing definition, is usually entered manually into the routers. Further information regarding communication networks, particularly on system level, can be obtained from Reference [2].

FIG. 2A represents the forwarding of a message from the external system 114 to sub-system 3 from the point of view of different components of the security system. Situated in connection with router 110, yet conveniently separate in its functions, sub-system 1 receives all communication between the external network and sub-system 3 that is to be forwarded. The mail book of sub-system 1, which can be realized, for example, as a table to be saved in the memory, has identifiers located in sub-system 2 corresponding with each identifier of the apparatus of sub-system 3, being, for example, network addresses or host addresses. When sub-system 1 receives a new message 202, it is temporarily saved, for example, in the RAM (Random Access Memory), and message 202 is not handled, opened or in any way changed before the actual stage of activating viruses. Sub-system 1 includes by default hardware compatible with sub-system 3, nowadays typically a personal computer with, for example, MSDOS (Microsoft Disk Operating System)/Windows operating system. Although router 110 may have memory capacity in itself and its processor may have computational capacity to run the presented anti-virus method to its full extent, even separate hardware can be used in implementing the security system, locating it, for example, between the router and the hub. In such a case, a possible virus activation would not necessarily have as disastrous an effect on the function of the router and the messages contained therein as in a completely integrated router/security system solution. Even sub-system 2 can be separated from sub-system 1 into its own hardware. Next, in sub-system 1 a search is conducted in order to detect viruses having attached themselves to message 202. If a virus is detected, an alarm is given, i.e. a protection command 204 is sent to sub-systems 2 and 3. Alternatively, if the virus is of a known type and can reliably be removed by the security system from the contaminated message, the security system can continue its normal activities, however, saving data regarding the virus detection and the corrective measures taken, for example, in a special log file. The clean message is forwarded through sub-system 2 to its recipient in sub-system 3.

Sub-systems 1 and 2 can be connected with system X, for example, sub-system 210, i.e. a “dumping ground”, where, once a protection command arrives, the message causing the alarm is saved along with, for instance, other messages and files in sub-system 2 at that time for further examination. Then, provided that the conditions for secure functioning of the security system still prevail, sub-systems 1 and 2 can almost with no delay continue their normal activities, while the connected system 210 will take care of the actual virus analysis. As one condition for secure functioning can be defined, for example, the re-starting of sub-systems 1 and 2 and/or the emptying of their working storage.

FIG. 2B correspondingly presents the forwarding of a message from the local area network, i.e. from sub-system 3 of the security system to an external system 114. If a virus is detected in a message 206 sent from sub-system 3, a protection command 208 is immediately sent to sub-systems 1 and 2. The sub-systems 1 and 2 of receiving and sending direction as shown in FIGS. 2A and 2B contain functions similar in their logic, and they can be physically located in either common or separate hardware, whichever is desired. If the implemented solution is based on at least partially common hardware, the protection commands should be conveniently forwarded to sub-systems 2 and 3 of both data transfer directions, so that communication is disrupted in both directions as well. One can thus ensure that viruses cannot link back to their direction of arrival and thereby possibly contaminate further computers.

FIG. 3 presents a flow chart showing one preferred embodiment of an anti-virus method carried out in sub-system 1 of the security system in accordance with the Invention. The actions of sub-system 1 are, as far as resources, for example the computational capacity, allow, constantly monitored 302, and not only when a message is received 304 from an external system 114 or sub-system 3. Sometimes it may be necessary to set a limit to the maximum duration of the virus search that must not be exceeded. The maximum search time allowed by the limit, that on its part defines the maximum delay caused to communication by the anti-virus method being presented and possibly mentioned in the specifications of the system, must on the average reliably detect messages contaminated by a virus, but in exceptional cases, the seave of the security system may let pass such messages that are contaminated by viruses the activation manner of which is unknown or by viruses that are otherwise unknown. Even if that happens, in some cases it is possible to protect oneself from additional damage or minimize the damages, if the virus has at some point been detected to begin with, despite having been able to intrude into the user's system. The monitoring of the security system is dealt with further on in greater detail, in connection with the description of the virus activation trials. Should the monitoring reveal a virus 303, an alarm is given and protection command 316 is sent.

The first step in a virus search is to search the message to be forwarded for viruses, using the means 306 of traditional anti-virus programs, looking for known viruses. For this purpose, one can use, for example, a database including finger prints of viruses. If the first step reveals a virus infection 308, sub-system 1 sends a protection command 316 to sub-systems 2 and 3. Otherwise, the search proceeds to the second step where one tries to activate 310 an unknown virus and thereby reveal itself. The security system goes through, for instance, all known virus activation types, and it possibly combines them taking place simultaneously or consecutively. New types of virus activation can, on the other hand, be added to the system whenever they come to one's attention. New types of virus activation detected by the security system can also be programmed to be automatically saved in its virus database. The security system is monitored in order to detect 311 unusual and thus actions possibly taken or indirectly caused by viruses. The activation of a virus in the security system is in principal to be preferred to its activation in the user's system, as the security system can after the virus activation be quickly isolated and does not, on the other hand, contain any relevant data in itself—at the most, a couple of unforwarded messages still located in the security system. Most of the time, messages sent via communication networks are saved in the sender's mailbox, in which case it is usually possible with no greater problems to re-send messages that have been destroyed during forwarding as a result of virus activation. From the point of view of conducting a search, the types of virus activation can be divided into two main groups: known and unknown types of activation. If the activation of a virus is detected 312, an alarm is given and protection command 316 is sent; otherwise, the message is forwarded 314 normally via sub-system 2.

Known types of virus activation include time-bound activations. A virus making use of time may become active when visiting the system, for example, for the third time, the date being 10 Sep. 2002. In order to detect this type of virus, one can, inter alia, run the time data, the so-called clock of the system, forward and backward, while this time run has possibly got to be carried out several times to ensure that the activation date is passed a sufficient number of times. The number of runs carried out by the security system must be rather high, changeable or at least in some way definable by the user, so that certain time-bound viruses may not, thanks to too low number of time runs alone, pass the searches on a regular basis. On the other hand, virus activations tied to, for example, memory management can be sieved in the same way with the help of multiple memory fill loops in which memory locations are repeatedly checked out, for example, by writing pseudo data on them. Some viruses will activate when handling files in a mass storage such as the hard disk. The activation of this type of viruses can be facilitated by automatic data processing carried out by the security system, for instance, by reading the pseudo data or writing on them as well as by generating and deleting pseudo files. Also calling functions pertaining to file management, i.e. merely the partial simulation of handling files may suffice to activate viruses. In addition to the manners mentioned above, even other methods to activate viruses are used, taking into consideration the characteristics of each type of virus activation.

It is possible that the activation of a virus is dependent on several different conditions being present, either simultaneously or consecutively. The conditions for a virus to activate may, on the other hand, change as the virus progresses from hardware to hardware. Nevertheless even then, one can by means of versatile and multiple activation attempts minimize the probability of a virus passing through the security system. On the basis of a logic that is either programmed by the user, pre-programmed, for example, during the publication stage or that is at least partially a random control logic, the security system can decide what activation methods shall be used, how many times they shall be repeated and how the activation methods shall be combined. In the method presented in FIG. 3, the stages 310 and 311 can thus be repeated in accordance with the above-mentioned logic before the message is finally confirmed as virus-free and forwarded. If separate security systems are placed at a number of different spots in the communication chain, the overall security level of the system will rise after multiple, independent checks to quite high a level.

In order to detect completely unknown viruses and their activation types, one can, on the other hand, try to predict possible new activation types or use some particular method to detect consequences of virus contamination or activation. One method helping to detect anomalities in messages that are to be forwarded is based on the multiple sending of messages. In the method in question, the sender of an e-mail will send at least two messages, A and B, which message B is either an identical copy of message A, or at least a precise description of the composition of message A. The comparison of messages A and B can be made already at the sending end, in sub-system 1 of the security system of the sending direction. Sub-system 1 is able to compare exactly the right messages as messages A and B, using the known identification technique. If, for example, the messages are in any case given individual IDs (IDentifiers), one can add the letters A and B to define the different copies of the same message. As an identifier one can use almost any usually distinctive part of the message, from the subject field and its contents to the payload or a part of it. If the comparison does not reveal any anomalities, i.e. the messages are either except identifiers and possible exact sending time identical, or the description of message A by message B is fully correct, sub-system 1 of the security system of the sending direction at the sending end will forward message A and either file or delete message B. If anomalities are detected, these will cause a virus alarm, as the said anomaly may be due to the attaching of a virus to either message. A simple technique to separate a contaminated message from an unharmed one is based on the re-sending of the message, where sub-system 1 requests the sender to re-send the message and once the message is received, compares it with previous messages. In practice, one can realize this by having the security system of the sending direction at the sending end inform the security system of the receiving direction at the receiving end, which communicate with each other as well, for example, by means of a message saying that the sender is asked to re-send the message. Thereafter the security system of the receiving direction forwards the request to the sender who sends a new copy of the message. Alternatively, the security system of the sending direction can comprise an own return channel to sub-system 3, for instance, to forward confirmation messages or requests for re-sending. If the security system is adapted to confirm to the sender all flawlessly received messages meant to be forwarded, the confirmation may be left unsent deliberately, when the sender automatically re-sends another copy of his message, now confirmed in the usual manner. When comparing copies of messages, one can conclude, for example, from the increase of the file size which message or messages a virus is attached to.

The above-presented method based on the multiple sending of messages can equally be applied at the receiving end where from an external system arrive at sub-system 1 of the security system of the receiving direction at least two messages that can be associated with each other with the help of their identifiers and that are compared with each other in order to detect anomalities. If the external system does not automatically send or is not programmed to send numerous copies of the message, the security system can, if desired, request the external system to re-send a message already received, using, for example, pre-programmed basic functions of the communication protocol such as, inter alia, the request for re-sending a message and the confirmation of the receipt of a message, and thereby obtain several copies of the message for examining. The request for re-sending can be forwarded to the original sender of the message or, alternatively, for example, to the mail server of the external system that will forward the request to the sender or deliver a possible copy of the message saved in its memory to the security system. In the latter alternative, detecting a virus may basically be more difficult, as the part carried out by the original sender of the copy is completely left out of the communication chain. The request for re-sending can be made cover only one part of all messages. For example, only messages with attached files would be examined by means of the comparison, as it is attached files that most of the time act as the carriers of viruses.

In the system presented above, the messages are created in the same system (the sender either in sub-system 3 or in an external system), so it is theoretically possible that all messages contain a virus and it appears in them in the same way. In such a case, comparing messages with each other would not yield a result, if, for instance, they all bear the contaminated attachment. To eliminate this risk, one can, if desired, build a security system where parallely to the sender, i.e. the control units (keyboard, mouse etc.) of sub-system 3 of the security system at the sending end another system is connected with, for example, sub-system 1 of the security system of the sending direction, including the programs and the data of sub-system 3 in such a way that message B is generated and saved in the parallel system in the same way as the message is generated and saved, or at least savable in sub-systems 1-3, if desired. One alternative for sending control message B (A) to sub-system 1 is now that only message A(B) is sent and at least one control message B(A) is saved in the sending and/or parallel system, and then the system making the comparison, sub-system 1, will make the comparison in the said sending/parallel system. Sub-system 1 can, for example, be programmed to analyse message A in order to establish its characteristics and to connect itself to the parallel system in order to compare the above-mentioned characteristics with the characteristics of message B saved in the parallel system. If sub-system 1 is in itself also the parallel system, i.e. it saves message B already when it is created or at the latest when it is sent, and if it, on the other hand, receives message A normally, the comparison will be quite easy, the connecting to a separate parallel system being unnecessary.

On the other hand, a parallel system can be connected at the sending end to the security system of the sending direction or, alternatively, to another network element suitable for data communication in a way where the said parallel system will forward messages, either passing by or through the security system of the sending end. In that case, further on in the message chain, for example at the receiving end, the security system of the receiving end compares the messages as described earlier, the difference to the solution for comparing messages presented afore being mainly that one of the messages originates from a parallel system connected to the sender's system, and not from the sender himself. The security system of the receiving end can, if necessary, request the security system of the sending end to re-send a message or, alternatively, request the sender/parallel system to do so, either directly or indirectly via the security system.

In the monitoring of the security system one will focus, inter alia, on the following particulars to detect viruses:

A change takes place in sub-system 1 before sub-system 1 has itself taken any actions causing changes in order to reveal a virus,
a change takes place in sub-system 1 where it is not question about an action taken by the sub-system to reveal a virus,
a message is sent to sub-system 2 or to another system without any command from sub-system 1,
a message is sent to sub-system 2 or to another system, but to a wrong address or to system X, if one is connected but to which basically no communication has been directed to,
a message does not leave for sub-system 2 or other system, although sub-system 1 has sent it there,
the monitoring software of the system detects an activated virus on some other basis.

When sub-system 1 upon an alarm forwards a protection command 316 to sub-systems 2 and 3, the sub-systems 1-3 will disrupt their data transfer connection, for example so that they can no longer receive or send messages. What is relevant to the actions caused by the protection command is that communication between sub-systems 1 and 2 and the user's system no longer runs before the cause of the virus alarm has been established and possibly contaminated files have been cleaned. One simple alternative to clean the security system is the re-installation of sub-systems 1 and 2, if desired, only after chosen files have been transferred, either automatically or on the basis of the user's command, to sub-system 210 for later analysis. Possible downtime affecting communication between the external network and system to be protected caused by the virus alarm of the anti-virus system and protection/analysis measures pertaining thereto can be minimized by taking into use a back-up system, for example, a parallel security system. If the virus can be analysed in sub-system 210, its “finger prints” can later be sent to known security systems and to the server of the developer of the security system, for instance, to be added to a virus database being regularly delivered to clients, so that the virus in question can later be identified already at the first stage 306 of the virus search.

The protection command is conveniently sent to sub-systems 2 and 3 using a separate and secure connection, even though a datalink shared with normal communication is possible. It is important for the forwarding of the protection command that the command be sent as quickly and reliably as possible to the recipient, and the protection command must reach the recipient, i.e. sub-system 2 or 3, before the virus manages to cause any damage to the said systems or propagate. For instance, when a contaminated message arrives from an external system 114 to router 110, the protection command from sub-system 1 must reach sub-system 3 before the virus and the connection between sub-systems 2 and 3 has to be able to be disrupted, so that the contaminated message is not forwarded to sub-system 3 at all. The connection can be disrupted, for example, on software basis, by shutting down data transfer services in the sub-systems in question. If the user's system, sub-system 3, uses, for example, traditional 10 Mbit/s Ethernet links, but hub 112 has the required logic to handle 10<−>100 Mbit/s speed conversion and the prioritization of different links, sub-system 1 of the security system placed in in connection with router 110 be directly connected by a 100 Mbit/s link to hub 112 being programmed to give the highest priority to data passing through the 100 Mbit/s link. In the equipment implementing the security system, a particular form is defined for the protection command, or at least a particular identifier helping receivers identify it. Also, if the connection from the sender of the protection command to its recipient is separate, one can regard almost any data sent through it to constitute sufficient grounds for disrupting the connection. In such a case, when a virus manages to get hold of the security system, sending own messages bearing viruses using the separate connection, they as well will set off the alarm. High execution priorities must be defined for the software and processes implementing the security system, covering all sub-systems 1-3, so that protection commands are sent and received with no delay, whether the protection command is forwarded via a separate connection or not. Sub-system 2 may be set to deliberately delay the forwarding of messages, for example, by means of a parameter to be adjusted by the user, so that contaminated messages have with certainty not been forwarded when a possible protection command arrives. On the other hand, it is possible to program hub 112 or other similar node element of sub-system 3 to read the protection commands and to disrupt communication transferred through it. In that case, one would not need to establish for each element of sub-system 3 a separate connection to sub-system 1 or program a support for interpreting a protection command.

In a further preferred embodiment of the Invention (see FIG. 4), sub-system 2 is left out of the security system, if the protection command 402 reaches its recipient quicker than takes time for the contaminated message to be sent and received. Sub-system 210 can still be left for the analysing of viruses. The quick transfer of the protection command can be realized, for example, with the help of a fast separate data connection. Also the high priority of processes pertaining to the handling of protection commands of the software of the security system and slowing down other communication to a level lower than the maximum will increase the chances to detect viruses before they propagate. On the other hand, the said slowing down can be linked to the virus detection, for example, by sub-system 1 slowing down its own communication as defined upon detecting a virus, with sub-systems 2 and 3 acting accordingly upon having received a protection command. In such a case one achieves as high a level of protection against virus attacks, yet the system remains simple in its structure and enables lower hardware requirements than the former embodiment.

FIG. 5 presents a further preferred embodiment of the Invention, where the security system according to the afore-presented first preferred embodiment of the Invention isolates the user's system, i.e. sub-system 3, from the external system 114 to hinder unauthorized intrusion attempts. Data, for example files and messages, is transferred from the external system 114 to sub-system 3 through sub-systems 1 and 2. In the example of the figure, sub-system 1 that does not have any simultaneous connections to the external system and sub-system 2, has received a message from the external system. Next, the connection between the external system 114 and sub-system 1 is disrupted before a connection is established between sub-systems 1 and 2 and the message is forwarded to sub-system 2 (see stage A of the figure). Thereafter, the connection between sub-systems 1 and 2 is disrupted before a connection is established between sub-systems 2 and 3 and the message is forwarded to the recipient in sub-system 3 (see stage B of the figure). Now also the connection between external system 114 and sub-system 1 can be opened again (cf. dashed line in the figure). Therefore, no real-time connection between the external system 114 and sub-system 3 exists and sub-system 3 is isolated. The disrupting of connections can be realized, for example, on software basis by shutting down data transfer services in sub-systems 1 and 2. Attempted attacks against sub-system 3 can nevertheless be based on, inter alia, hostile programs sent with messages (cf. Trojan horses) that perform hidden actions such as collecting of information in sub-system 3 or that try to interfere with its activities. Programs of this kind can, however, be detected by the virus search and activation methods of sub-system 1 before they access sub-system 3. A similar procedure can be followed, if desired, when transferring data from sub-system 3 to the external system 114. Of course, in both data transfer directions there are even other alternatives for disrupting and establishing connections between sub-systems and the external network guaranteeing staggered data transfer, where no real-time connection between the external network and sub-system 3 can come into being at any stage. If the connections being used are duplex, sub-system 1 of the receiving direction and sub-system 2 of the sending direction, and on the other hand, sub-system 2 of the receiving direction and sub-system 1 of the sending direction can be conveniently placed in each other's proximity.

In a further preferred embodiment of the Invention (see FIG. 6), apparatus 606 is connected to a network element such as the user's computer 602, router, switch, server 604 or hub, in order to activate and detect viruses. The link 608 can be realized, for example, with the help of a Ethernet type of link using a pair cable or wireless via a WLAN connection. Contrary to former embodiments, apparatus 606 does in this case not forward messages, but at least a part of the messages sent, intended to be sent or received by network element 602, 604 is transferred to it for examination. If all messages are not regularly sent to the said apparatus 606, or, alternatively, apparatus 606 does not fetch them from network elements 602, 604 by itself, one can at least program, for instance, a desired percentage of all messages to be forwarded to apparatus 606 for virus search, and the messages included in this share can be chosen on the basis of different criteria. One criterion could be that messages with attachments are always examined. Apparatus 606 which could be, for example, a computer, includes to a relevant extent the same software as sub-system 1 of the security system presented afore, in addition to which one can include, if needed, features of sub-system 2, either in the same or in at least partially detached sub-equipment. The identifiers, such as domain or host names of the actual recipients of messages to be examined obtained from network element 602, 604 can be preserved and communication to the said recipients be simulated by adding the identifiers either on software basis or even in another manner to sub-equipment separated from apparatus 606, which thus partially equals sub-system 2 of the security system presented afore, functioning as an “interim storage” for messages where apparatus 606 can, as a test, forward messages it has received, but in this case does not actually forward the messages the way sub-system 2 does. Therefore, even methods to detect virus activation pertaining to the forwarding of messages can be used in the afore-mentioned apparatus 606.

The apparatus includes the necessary memory, for example a RAM memory circuit 610 and a non-volative memory 612 such a a hard disk or diskette drive for saving commands of programs, for example anti-virus software, and for handling files or the simulation of handling files, as well as a processor 614 for carrying out the commands mentioned. Apparatus 606 receives a message from the network element 602, 604 connected thereto and searches the message for known and unknown viruses using techniques mentioned earlier in this description, inter alia, the method in FIG. 3. For the duration of the message examination, other communication in network element 602, 604 connected to apparatus 606 can be interrupted, for example on a software basis, until apparatus 606 informs the said network elements 602, 604 that the message is clean, or alternatively, the virus search may be completely independent from the actual communication in the other system. Correspondingly, one can delay the forwarding of a message that is to be examined to the actual recipient, until the message has been confirmed to be virus-free by apparatus 606. Apparatus 606 can, on the other hand, be programmed to return the examined message even in its entirety to network element 602, 604, in which case network element 602, 604 will forward the said examined message as such, and the original, un-examined copy of the message is not sent at all. Network element 602, 604 can alternatively be programmed to delete the original message immediately after a copy of the message has been sent to apparatus 606 for examining. Thus can the risk of an un-examined message travelling further be minimized.

Having detected a virus infection in a message that is to be forwarded, apparatus 606 saves the particulars of the occurrence in the memory 610, 612, and if the connection between apparatus 606 and network element 602, 604 is duplex, while the transfer directions may be separated from each other, it also conveniently informs the said network element 602, 604 of the virus alarm by means of a message. In this embodiment, the Invention can easily be attached to another system already in use, as the minimum requirement regarding the other system is only a data transfer connection for forwarding the message besides its actual target also to apparatus 606 in accordance with the Invention. Furthermore, a person skilled in the art can, using software, simply carry out a control logic on software basis for interrupting communication until information from apparatus 606 concerning the message being clean has been received, or corresponding functions in connection with a virus alarm.

The afore-presented security system, method and apparatus for repelling computer viruses and isolating data deal with a fundamental problem concerning the data security of information systems and networks; how unknown viruses can be detected and their attacks resisted. Traditionally, a virus is detected only after becoming active in the target system, after which the virus is identified and the detected finger prints are added to the databases of anti-virus software. This kind of solution requires immediate action from a number of different parties in order to elminate a more serious epidemy; the first detector of the virus must instantly deliver the contaminated file or similar item to the party responsible for updating the anti-virus software, the updater must issue a new version of the database of the anti-virus software and deliver it to every user who in the end is supposed to update the database of his client application to correspond with the additions made. It is obvious, that if one of the above-mentioned stages of the action chain is omitted or it fails for some other reason, for example due to damaged mail or data transfer connections, nothing will hinder the spreading of the virus. The proposed new solution initially uses a virus database to detect known viruses, but will then commence activation attempts and the general monitoring of the system to detect new, still unknown viruses. If a virus is activated, the damages will be limited to the restorable security system and communication is disrupted to prevent the spreading of contaminated messages to the external or the internal network. The reliability of performance of the system is increased by forwarding the protection commands via separate, secure connections. The security system monitors itself even when there are no actual messages to be forwarded, so that possibly undetected viruses would be found as early a stage as possible. With the help of the security system the user's system can be separated from the external network in order to hinder attempts to intrude.

The afore-presented embodiments of the Invention are only non-limiting examples, and the final implementation of the Invention may thus vary within the inventive idea covered by the Patent claims to be presented further on in this application.

### REFERENCES

[1] The Network Administrators' Guide, URL: http://tldp.org/LDP/nag/, Olaf Kirch 1996
[2] Computer Networks: A Systems Approach, Morgan Kaufmann, ISBN 1-55860-514-2 1999

1. A security system for repelling viruses in computers and computer networks, which security system is adapted to forward messages, characterized in that the security system includes a first sub-system (1) to detect unknown viruses, which sub-system (1) is adapted in connection with the forwarding of messages or with other action or, in a timed manner, to perform at least one action to activate unknown viruses.

2. A security system in accordance with claim 1, characterized in that it is adapted to forward an alarm caused by the detection of a virus to at least one system connected to the security system (2,3).

3. A security system in accordance with claim 1, characterized in that it is adapted to break the connection to at least one other system (2,3, 114) on the basis of an alarm caused by the detection of a virus.

4. A security system in accordance with claim 1, characterized in that it additionally includes a second sub-system (2) for forwarding messages from the first sub-system (1) to at least one system (3, 210, 114) connected to the security system.

5. A security system in accordance with claim 1, characterized in that it additionally includes a third sub-system (3) that is adapted to break the connection to at least one other sub-system (1,2) upon receiving an alarm.

6. A security system in accordance with claim 5, characterized in that the second sub-system (2) includes an identifier which corresponds identifier of the apparatus (3) of the third sub-system.

7. A security system in accordance with claim 1, characterized in that the first sub-system (1) is adapted to monitor its actions to detect viruses.

8. A security system in accordance with claim 2, characterized in that the alarm is a message or at least a part of a message that is forwarded to the recipient quicker than other communications.

9. A security system in accordance with claim 5, characterized in that the third sub-system (3) includes at least one computer or one network element including a computer.

10. A security system in accordance with claim 2, characterized in that the alarm is forwarded via a separate connection.

11. A security system in accordance with claim 1, characterized in that the said action is one the following: altering the time data, altering the contents of the memory, handling of files or at least its partial simulation.

12. A security system in accordance with claim 1, characterized in that it is adapted to detect an activated virus when at least one of the following conditions is met: a change takes place in the first sub-system (1) prior to actions causing changes carried out by the first-mentioned sub-system, a change takes place in the first sub-system (1) that is not an action taken by the said sub-system to detect a virus, a message leaves for another system without command from the first sub-system (1), a message leaves for another system to a wrong address or to a system which no communication has been directed to, a message does not leave for another system although it has been sent there.

13. A security system in accordance with claim 1, characterized in that it is adapted to combine activation measures of viruses to take place either simultaneously or consecutively in time.

14. A security system in accordance with claim 1, characterized in that it is adapted to choose one or more of the following logics when trying to activate viruses: one defined by the user, pre-programmed or at least partially random logic.

15. A security system in accordance with claim 5, characterized in that to it has been connected parallel with a third sub-system (3) a system that is adapted to save a message sent from the third sub-system (3).

16. A security system in accordance with claim 15, characterized in that the first sub-system (1) is adapted to compare in a parallel system a message sent from the third sub-system (3) to the first sub-system (1) and additionally saved in the parallel system in order to detect an anomaly caused by a virus.

17. A security system in accordance with claim 15, characterized in that the above-mentioned parallel system is adapted to forward a message saved by it.

18. A security system in accordance with claim 1, characterized in that it is adapted to examine messages forwarded through it in order to detect known viruses.

19. A security system in accordance with claim 4, characterized in that in order to isolate data between the first (114) and the second (3) system, it has been adapted to transfer data between the first (114) and the second (3) system through the first (1) and the second (2) sub-system, which security system is adapted to disrupt the connection between the first system (114) and the first (1) sub-system before a connection is established between the first (1) and the second (2) sub-system, and is adapted to disrupt the connection between the first (1) and the second (2) sub-system before a connection is established between the second sub-system (2) and the second system (3).

20. A security system for repelling viruses in computers and computer networks, which security system is adapted to forward messages, characterized in that the security system includes a first sub-system (1) for detecting unknown viruses, which first sub-system (1) is adapted to compare messages with at least partially identical identifiers with each other in order to detect unknown viruses.

21. A security system in accordance with claim 20, characterized in that it is adapted to request the sender of the above-mentioned messages with the same identifiers to re-send at least one message with the same identifier and further adapted to compare at least one re-sent message received with the above-mentioned original messages in order to detect messages containing viruses.

22. A method for repelling viruses in computers and data networks, characterized in that it is carried out in a security system including a first sub-system (1) for forwarding messages and for detecting viruses, which first sub-system (1) can, with regard to data transfer, be isolated from the rest of the system, which method includes the steps where:
the functions of the system are monitored in order to detect a virus (311),
a virus (312) is detected when at least one of the following conditions are met:
a change takes place in the first sub-system (1) prior to actions causing changes carried out by the first-mentioned sub-system, a change takes place in the first sub-system (1) that is not an action taken by the said sub-system to detect a virus, a message leaves for another system without command from the first sub-system (1), a message leaves for another system to a wrong address or to a system which no communication has been directed to, a message does not leave for another system although it has been sent there,
an alarm (316) is given.

23. A method for repelling viruses in computers and computer networks, characterized in that the method has stages where:
at least one action in the system is taken in connection with the forwarding of messages or other action, or in a timed manner, in order to activate a virus (310),
the actions of the system are monitored in order to detect an occurrence initiated by virus activation (311),
an alarm (316) is given when a virus is detected (312).

24. A method in accordance with claim 23, characterized in that the system running it includes a first sub-system (1) for forwarding of messages and for detecting of viruses, which first sub-system (1) can be isolated from another system as to communications.

25. A method in accordance with claim 23, characterized in that the action taken to activate a virus is one of the following: altering the time data, altering the contents of the memory, handling of files or at least its partial simulation.

26. A method in accordance with claim 23, characterized in that it is run in a security system including a first sub-system (1) and a second sub-system (2) in which method the activation of a virus is detected when at least one of the following conditions is met: a change takes place in the first sub-system (1) prior to actions causing changes carried out by the first-mentioned sub-system, a change takes place in the first sub-system (1) that is not an action taken by the said sub-system to detect a virus, a message leaves for another system without command from the first sub-system (1), a message leaves for another system to a wrong address or to a system which no communication has been directed to, a message does not leave for another system although it has been sent there.

27. A method in accordance with claim 23, characterized in that in order to activate a virus, activation measures are combined to take place either simultaneously or consecutively in time.

28. A method in accordance with claim 23, characterized in that the logic to be used when trying to activate a virus is one of the following: one defined by the user, pre-programmed or at least partially random logic.

29. A method in accordance with claim 23, characterized in that it also includes a stage where known viruses (306) are searched for on the basis of their characteristics.

30. A method in accordance with claim 23, characterized in that in order to isolate data between the first (114) and the second (3) system the method is run in a security system that includes a first (1) and a second (2) sub-system through which sub-systems (1,2) data is transferred between the first (114) and the second (3) system phase by phase, in which phases:
the connection for data transfer is disrupted between the first system (114) and the first sub-system (1),
a connection for data transfer is established between the first sub-system (1) and the second sub-system (2),
the connection for data transfer is disrupted between the first sub-system (1) and the second sub-system (2),
a connection for data transfer is established between the second sub-system (2) and the second system (3).

31. An apparatus for repelling viruses in computers and computer networks, which apparatus includes equipment for saving data (610,612) and for handling data (614) and equipment for transferring data (608) with another apparatus, characterized in that the apparatus is adapted to receive a message from the said other apparatus and to perform at least one action to activate viruses contained in the message.

32. An apparatus in accordance with claim 31, characterized in that the action mentioned is at least one of the following: altering the time data, altering the contents of the memory, handling of files or at least its partial simulation.

33. An apparatus in accordance with claim 31, characterized in that it is adapted to detect virus activation when at least one of the following conditions is met: a change takes place prior to actions caused by changes made by the apparatus, a change takes place that is not an action taken by the apparatus to detect a virus.

34. An apparatus in accordance with claim 31, characterized in that it is adapted to send a message to either a sub-assembly of the apparatus or to the other apparatus mentioned, and it is adapted to detect virus activation when at least one of the following conditions is met: a message leaves without authorization from the anti-virus software of the apparatus, a message leaves for an address it has not originally been directed to, a message does not leave although it has been given a command to be sent.

35. An apparatus in accordance with claim 31, characterized in that it is adapted to combine virus activation measures to take place either simultaneously or consecutively in time.

36. An apparatus in accordance with claim 31, characterized in that it is adapted to choose as the logic to be used when trying to activate a virus one of the following: one defined by the user, pre-programmed or at least partially random logic.

37. An apparatus in accordance with claim 31, characterized in that it is adapted to examine the message mentioned in order to detect known viruses.

38. An apparatus in accordance with claim 31, characterized in that it is adapted to monitor its functions in order to detect viru
